(19) United States
(12) Patent Application Publication
(10) Pub. No.: US 2020/0306820 A1
(43) Pub. Date: Oct. 1, 2020

(54) SOCKET PUNCHES

(71) Applicant: Snap-on Incorporated, Kenosha, WI (US)

(72) Inventors: Daniel M. Eggert, Kenosha, WI (US); Steven R. Wente, Kenosha, WI (US); David G. McGreal, Twin Lakes, WI (US); Jeffrey M. Arendt, Union Grove, WI (US)

(73) Assignee: Snap-on Incorporated, Kenosha, WI (US)

(21) Appl. No.: 16/433,754

(22) Filed: Jun. 6, 2019

Related U.S. Application Data
(63) Continuation-in-part of application No. 16/258,032, filed on Jan. 25, 2019.

(51) Int. Cl. B21J 13/02; B25B 23/00; B23P 17/02; B23H 9/12; B21K 1/76; B23H 5/06

(52) U.S. Cl. CPC B21J 13/02; B25B 23/0057; B23P 17/02; B25B 15/001; B21K 1/762; B23H 5/06; B23H 9/12

(57) ABSTRACT

A punch, such as a socket punch, with an angle on a portion of the punch and method of manufacturing a punch with an angle on a portion of the punch using wire EDM. A punch for a cold forming process includes a base portion adapted to be a structural backbone for the punch and a work portion extending from the base portion that performs a punching operation. In addition, grooves and a hex portion are formed in the working portion with an electric discharge machining (“EDM”) machine. Further, a cone point is machined on an end of the hex portion and a land area with an inwardly tapered angle formed between the hex portion and the cone point. The punch can be manufactured more quickly and from a CAD model, therefore removing the need for over-specialized equipment and improving manufacturing times.

### CROSS-REFERENCE TO RELATED APPLICATIONS

This application is a continuation-in-part of U.S. patent application Ser. No. 16/258,032, filed Jan. 25, 2019, the contents of which are incorporated herein by reference in its entirety.

### TECHNICAL FIELD OF THE INVENTION

The present invention relates generally to punches and manufacturing methods for punches. More particularly, the present invention relates to socket punches with a specific configuration and methods of manufacturing such socket punches using electrical discharge machining.

### BACKGROUND OF THE INVENTION

Punches are tools used to force a hole into a material, such as a work piece. Typically, the punch is operated in a “cold work” manner to punch a hole without the use of additional heat, as with hot extrusion or other “hot work” operations. Punches are forced or “punched” into the work piece, reforming the material to the shape of the punch.

Punches are manufactured in a variety of ways, but are normally formed by grinding a punch blank to a desired geometric configuration. However, grinding requires specialized grinding equipment, extended time to manufacture the punch, and additional quality control procedures to ensure that the finish punch product meets required specifications. In addition, it is not possible to grind the punch blank to certain, desired geometric configurations

### SUMMARY OF THE INVENTION

The present invention broadly comprises a method of manufacturing a punch, such as a socket punch, using wire electrical discharge machining (“wire EDM”). In an embodiment, the process includes the steps of: (1) forming a blank; (2) holding the blank with an adapter; (3) manufacturing grooves into the working portion of the blank using wire EDM techniques; (4) manufacturing a side relief of the working portion using wire EDM techniques; (5) milling the working portion to a final shape and size; and (6) machining a cone point onto an end of the working portion. The present invention allows the punch to be manufactured by “burning” the punch geometry with the wire based on a computer-aided design (“CAD”) model, thereby removing the need for specialized equipment, such as grinding equipment, and improving manufacturing times and quality, consistency and efficiency.

The present invention also broadly comprises a method of manufacturing a punch including forming a blank, machining a geometry of the blank with an EDM machine, milling a desired geometry of the blank to obtain a final geometric size and configuration on a portion, and machining a cone point on an end of the portion to form the punch.

An embodiment of the present invention broadly includes a punch with a desired geometry of the blank to obtain a final geometric size and configuration including an angle on a portion of the punch. The final geometric size and configuration may be formed on a land area of the punch.

Further, another embodiment the present invention broadly comprises a method of manufacturing a punch including forming a blank, machining a geometry of the blank with an EDM machine, milling a desired geometry of the blank to obtain a final geometric size and configuration including an angle on a portion of the punch, and machining a cone point on an end of the portion to form the punch. The final geometric configuration may be formed on a land area of the punch.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side perspective view of a punch blank according to an embodiment of the present invention.

FIG. 2 is a side perspective view of an EDM machine manufacturing a punch blank held by an adapter according to an embodiment of the present invention.

FIG. 3 is a side perspective view of an EDM machine manufacturing grooves into a punch blank according to an embodiment of the present invention.

FIG. 4 is a side perspective view of an EDM machine manufacturing a relief of the working portion according to an embodiment of the present invention.

FIG. 5 is a side perspective view of a milling machine milling the working portion to a final hex size according to an embodiment of the present invention.

FIG. 6 is a side perspective view of a completed punch with a cone point machined on the end of the working portion according to an embodiment of the present invention.

FIG. 7 is a flow chart outlining a method of manufacturing a punch according to an embodiment of the present invention.

FIG. 8 is a side perspective view of a completed punch with an angle on a land area according to an embodiment of the present invention.

FIG. 9 is a cross sectional view of a completed punch with an angle on a land area according to an embodiment of the present invention.

FIG. 10 is a flow chart outlining a method of manufacturing a punch according to an embodiment of the present invention.

### DETAILED DESCRIPTION OF THE EMBODIMENTS

While the present invention is susceptible of embodiments in many different forms, there is shown in the drawings, and will herein be described in detail, a preferred embodiment of the invention with the understanding that the present disclosure is to be considered as an exemplification of the principles of the invention and is not intended to limit the broad aspect of the invention to embodiments illustrated. As used herein, the term “present invention” is not intended to limit the scope of the claimed invention and is instead a term used to discuss exemplary embodiments of the invention for explanatory purposes only.

The present invention broadly comprises a punch with an angle on a portion of the punch and a method of manufacturing a punch, such as a socket punch, with an angle on a portion of the punch using wire EDM. In an embodiment, a blank is formed; the blank is held with an adapter; grooves are machined in the working portion using wire EDM; the side relief of the working portion is manufactured using wire EDM; the working portion is milled to a final size; a cone point is formed on the end of the working portion; and an angle is formed on a land area around the cone point substantially adjacent to the end of the working portion. The above process allows the punch to be manufactured more quickly and from a CAD model, therefore removing the need for specialized equipment and improving manufacturing times, efficiency, quality and consistency.

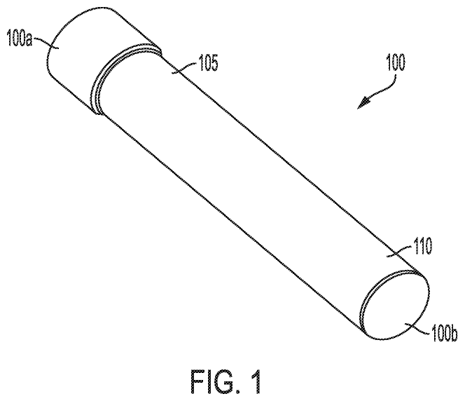

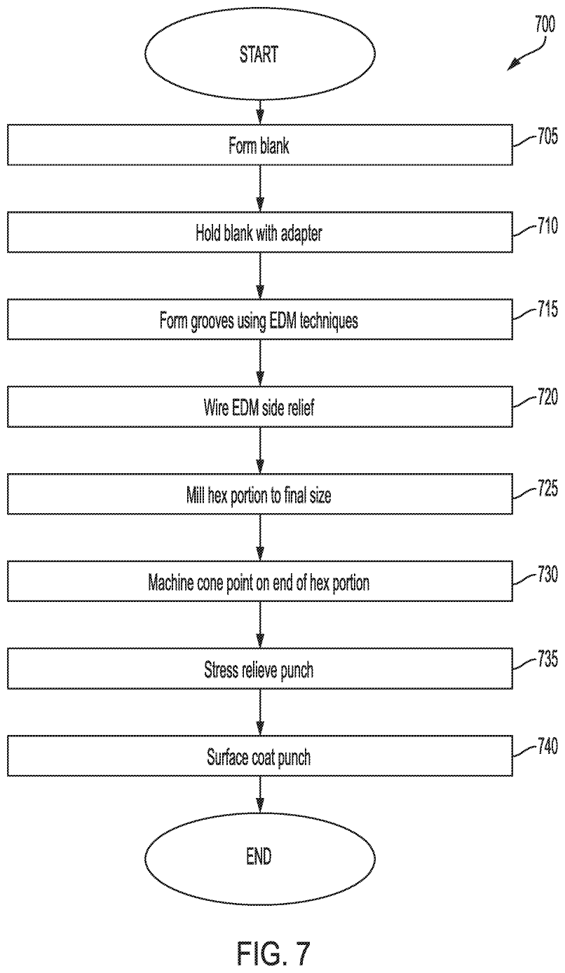

Referring to FIG. 1, in an embodiment, a blank 100 includes a first end 100a and an opposing second end 100b. The blank 100 can include a base portion 105 that acts as a structural backbone of the blank 100, and a working portion 110 intended to perform the punching operation when complete and in use. The blank 100 can be any material, but in an embodiment, is made of Crucible Particle Metallurgy (“CPM”) T-15 steel. As discussed below with respect to FIG. 7, the manufacturing process includes forming a blank, such as the blank 100 shown in FIG. 1.

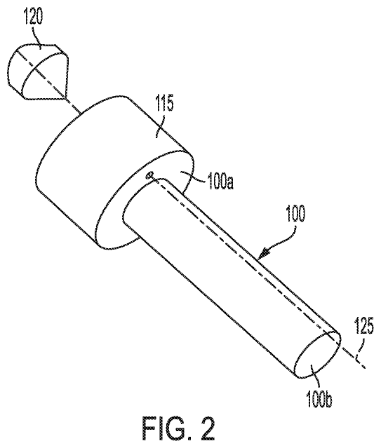

Referring to FIG. 2, a side perspective view of an adapter 115 holding a blank 100, and an EDM machine 120 manufacturing a blank 100 held by the adapter 115, according to an embodiment of the present invention, is shown. As shown, the EDM machine 120 can include a wire 125 that performs the machining/manufacturing operation of the EDM machine 120. The wire 125 can have an approximately 0.010″ diameter, although the present invention is not so limited.

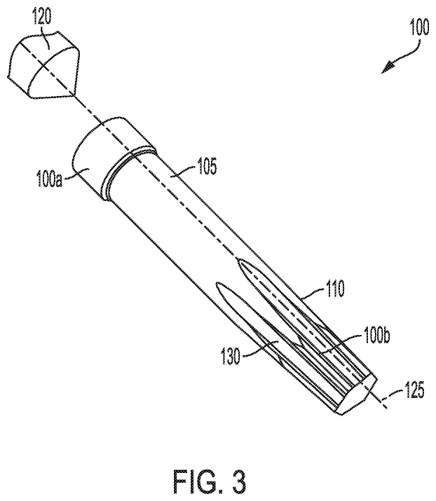

Referring to FIG. 3, a side perspective view of an EDM machine 120 manufacturing grooves 130 into a blank 100 according to an embodiment is shown. As shown, the wire 125 can be located at an angle with respect to the axis of the blank 100. For example, and without limitation, the wire 125 can be angled between 1.25 degrees to 2.00 degrees to avoid cutting the base portion 105 during the machining operation. By angling the wire 125, the punch, when completed, can be easily pulled out of a socket in a cold forming process.

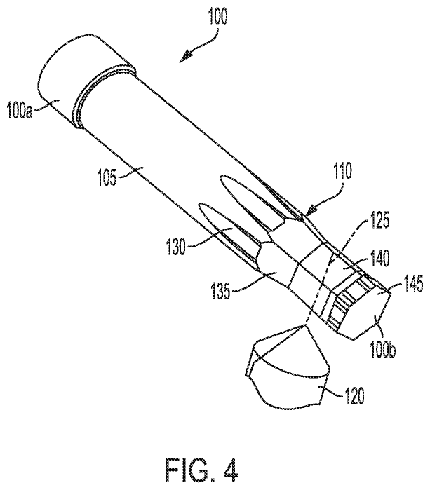

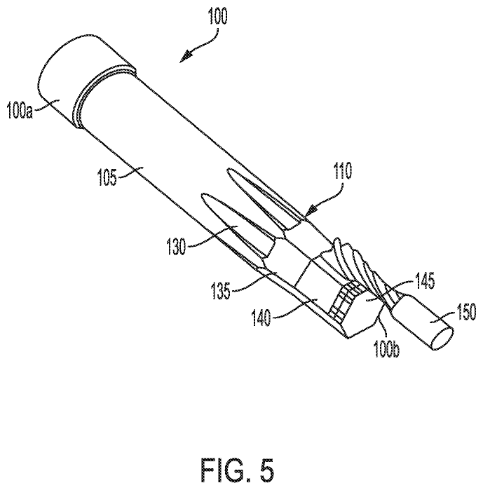

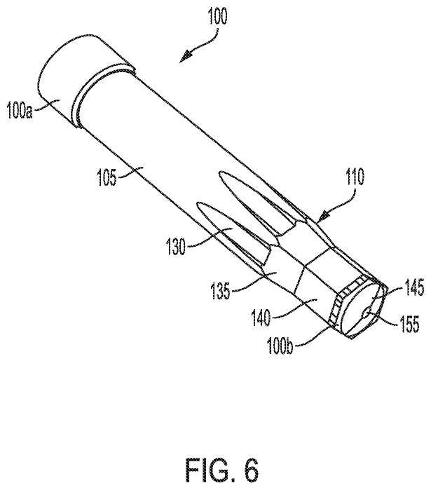

Referring to FIG. 4, a side perspective view of an EDM machine 120 manufacturing a relief of the working portion 110 according to an embodiment is shown. For example, the EDM machine 120 can manufacture a transition portion 135 leading to a hex portion 140 using wire EDM techniques. The hex portion 140 can extend from an end of the transition portion 135 to a hex end portion 145. As shown in FIG. 5, the working portion 110, and specifically the hex portion 140 in some embodiments, can be milled by a milling machine 150 to a final hex size of the working portion 110/hex portion 140. As shown in FIG. 6, a cone point 155 can then be machined into the hex end portion 145 of the blank 100 to complete the machining portion of the process.

FIG. 7 illustrates a method of manufacturing a punch 700 according to an embodiment of the present invention. As shown, the method 700 begins and proceeds to step 705 where a blank is formed, as shown in FIG. 1. The method 700 then proceeds to step 710 where the blank 100 is held by an adapter 115, as shown in FIG. 2. Step 715 then follows, where grooves 130 can be formed in the blank 100 on the working end 110, as shown in FIG. 3. The method 700 then proceeds to step 720, where the side relief of the working end 110 is machined. It is in this step where the where the transition portion 135 and the hex portion 140 can be machined into the blank using EDM techniques, as shown in FIG. 4. The method 700 can then proceed to step 725, where the hex portion 140 is milled to its final size as shown in FIG. 5, and then to step 730, where the cone point 155 is machined into the hex end portion 145.

The method 700 can then proceed to step 735, where the punch is stress relieved. For example, the punch can be stress relieved at 1025° F. for two hours. The method 700 can then proceed to step 740, where the punch is surface coated. For example, the punch can be coated with aluminum chromium nitride or titanium nitride.

The above steps in FIG. 7 and elsewhere in the specification are recited in a certain chronological order, but such an order is not necessarily required to affect the present invention unless expressly stated in the claims below. Further, certain steps may be omitted from the method 700 and unless expressly recited in the claims below, are optional.

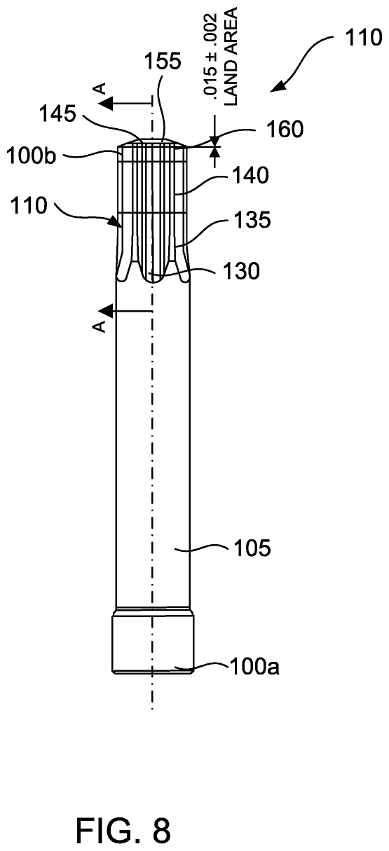

Referring to FIG. 8, a side perspective view of a completed punch with an angle on a land area according to an embodiment of the present invention is shown. As described above, a blank 100 includes a first end 100a, an opposing second end 100b, a base portion 105 that acts as a structural backbone of the blank 100, and a working portion 110 intended to perform the punching operation when complete and in use. An EDM machine can be used to manufacture grooves 130, a relief of the working portion 110, such as transition portion 135 leading to hex portion 140, into a blank 100 using wire EDM techniques. The hex portion 140 can extend from an end of the transition portion 135 to a hex end portion 145 and a cone point 155 can then be machined into the hex end portion 145 of the blank 100.

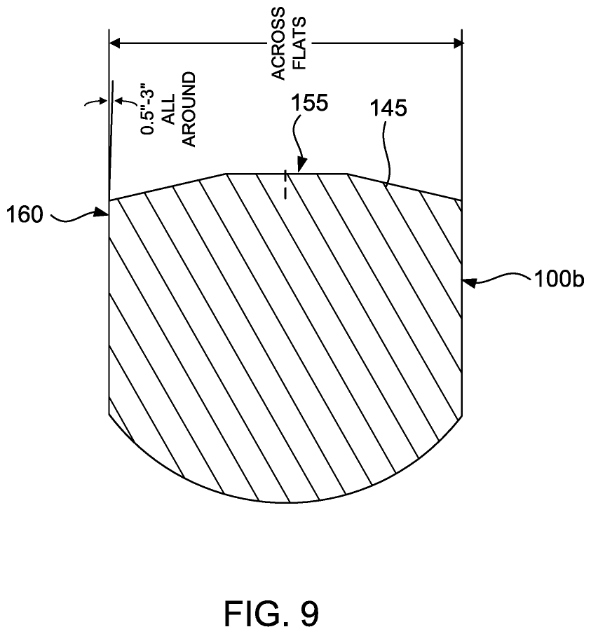

In addition, the hex end portion 145 may have a land/forming area 160 machined around the working end 110 between the hex portion 140 and the cone point 155. The land area 160 may have an inwardly tapered angle relative to the hex portion 140 of the punch. As shown in FIG. 9, the tapered angle of the land area 160 may be from about 0.5° to about 3° around the hex end portion 145. More specifically, the tapered angle of the land area 160 may be from about 1.2° to about 2.2°. An EDM machine can be used to manufacture the land area 160 with the tapered angle. By angling the land area 160, the punch, when completed, can be more easily pulled out of a workpiece in a cold forming process.

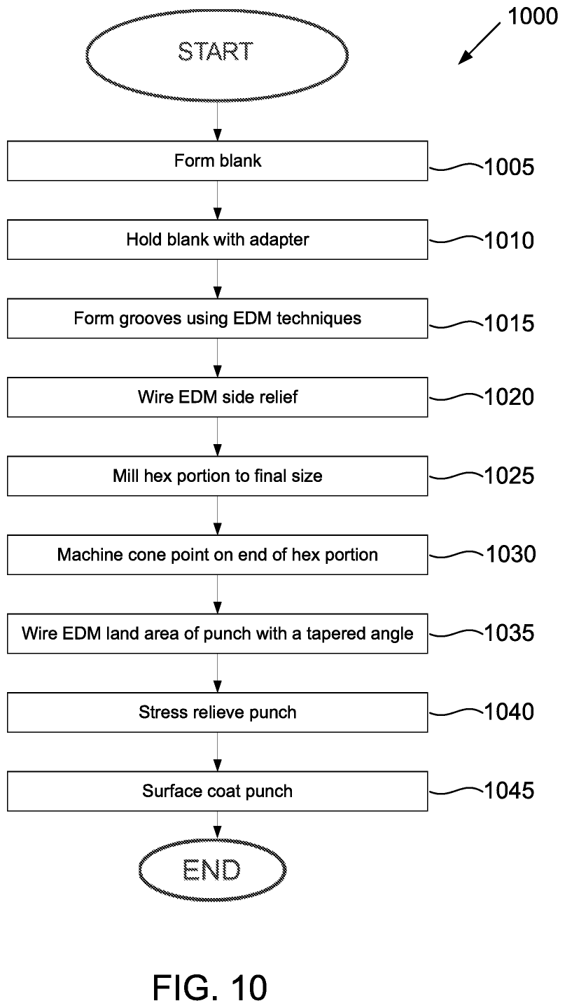

FIG. 10 illustrates a method of manufacturing a punch 1000 according to an embodiment. As shown, the method 1000 begins and proceeds to step 1000 where a blank is formed, as shown in FIG. 1. The method 1000 then proceeds to step 1010 where the blank 100 is held by an adapter 115, as shown in FIG. 2. Step 1015 then follows, where grooves 130 can be formed in the blank 100 on the working end 110, as shown in FIG. 3. The method 1000 then proceeds to step 1020, where the side relief of the working end 110 is machined. It is in this step where the where the transition portion 135 and the hex portion 140 can be machined into the blank using EDM techniques, as shown in FIG. 4. The method 1000 can then proceed to step 1025, where the hex portion 140 is milled to its final size as shown in FIG. 5, and then to step 1030, where the cone point 155 is machined into the hex end portion 145. Step 1035 then follows, where a land area with an inwardly tapered angle is machined around punch 100 between the hex portion 140 and the cone point 155. The tapered angle of the land area 160 may be from about 0.5° to about 3° around the hex end portion 145. More specifically, the tapered angle of the land area 160 may be from about 1.2° to about 2.2°.

The method 1000 can then proceed to step 1040, where the punch is stress relieved. For example, the punch can be stress relieved at 1025° F. for two hours. The method 1000 can then proceed to step 1045, where the punch is surface coated. For example, the punch can be coated with aluminum chromium nitride or titanium nitride.

Again, the above steps in FIG. 10 and elsewhere in the specification are recited in a certain chronological order, but such an order is not necessarily required to affect the present invention unless expressly stated in the claims below. Further, certain steps may be omitted from the method 1000 and unless expressly recited in the claims below, are optional.

As used herein, the term “coupled” and its functional equivalents are not intended to necessarily be limited to direct, mechanical coupling of two or more components. Instead, the term “coupled” and its functional equivalents are intended to mean any direct or indirect mechanical, electrical, or chemical connection between two or more objects, features, work pieces, and/or environmental matter. “Coupled” is also intended to mean, in some examples, one object being integral with another object.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A punch for a cold forming process, comprising:
a base portion adapted to be a structural backbone for the punch;
a work portion extending from the base portion, the work portion is adapted to perform a punching operation;
grooves formed in the working portion with an electric discharge machining (“EDM”) machine;
a hex portion formed in the working portion with the EDM machine;
a cone point machined on an end of the hex portion; and
a land area formed between the hex portion and the cone point, the land area having an inwardly tapered angle.

2. The punch according to claim 1, wherein the land area is formed between the hex portion and the cone point with the EDM machine.

3. The punch according to claim 2, wherein the inwardly tapered angle is approximately about 0.5° to about 3°, relative to the hex portion.

4. The punch according to claim 3, wherein the tapered angle is approximately about 1.2° to about 2.2°, relative to the hex portion.

5. The punch according to claim 1, wherein the punch includes a Crucible Particle Metallurgy (“CPM”) T-15 steel material.

6. A method of manufacturing a punch comprising:
holding a blank having a working portion with an adapter;
forming grooves in the working portion with an electric discharge machining (“EDM”) machine;
forming a hex portion in the working portion with the EDM machine;
milling the hex portion to obtain a final hex portion size;
machining a cone point on an end of the hex portion; and
machining a land area between the hex portion and the cone point, the land area having an inwardly tapered angle.

7. The method according to claim 6, wherein the tapered angle is approximately about 0.5° to about 3°, relative to the hex portion.

8. The method according to claim 7, wherein the tapered angle is approximately about 1.2° to about 2.2°, relative to the hex portion.

9. The method according to claim 5, wherein the EDM machine includes a wire having a diameter of approximately 0.010 inches.

10. The method according to claim 5, wherein the blank includes a Crucible Particle Metallurgy (“CPM”) T-15 steel material.

11. The method according to claim 6, wherein the land area is machined using the EDM machine.

12. A method of manufacturing a punch comprising:
forming a blank;
machining a geometry of the blank with an EDM machine;
milling a hex portion of the blank to obtain a final hex portion size;
machining a cone point on an end of the hex portion; and
machining a land area between the hex portion and the cone point, the land area having an inwardly tapered angle.

13. The method according to claim 12, wherein the tapered angle is approximately about 0.5° to about 3°, relative to the hex portion.

14. The method according to claim 13, wherein the tapered angle is approximately about 1.2° to about 2.2°, relative to the hex portion.

15. The method according to claim 12, wherein the step of machining a geometry of the blank includes forming grooves, the hex portion in a working portion of the blank, and a transition portion between the grooves and the hex portion.

16. The method according to claim 12, wherein the land area is machined using the EDM machine.

17. The method according to claim 12, further comprising stress relieving the punch.

18. The method according to claim 17, wherein the step of stress relieving the punch includes heating the punch to approximately 1025° F. for approximately two hours.

19. The method according to claim 12, further comprising surface coating the punch.

20. The method according to claim 19, wherein the step of surface coating the punch includes coating the punch with one of aluminum chromium nitride and titanium nitride.
